(19) United States
(12) Patent Application Publication
(10) Pub. No.: US 2003/0031533 A1
(43) Pub. Date: Feb. 13, 2003

(54) Round bale trailer

(76) Inventor: Ronald T. Delaurier, Laurier (CA)

Correspondence Address: ADRIAN D. BATTISON, ADE & COMPANY, 1700-360 MAIN STREET, WINNIPEG, MB, R3C 3Z3, CA

(21) Appl. No.: 09/927,443

(22) Filed: Aug. 13, 2001

(30) Foreign Application Priority Data
Aug. 10, 2001 (CA) 2,355,011

(51) Int. Cl. B60P 1/48

(52) U.S. Cl. 414/24.5; 414/111; 414/552

(57) ABSTRACT

A bale trailer for transporting round bales comprises an elongate frame having an end which is arranged to be coupled to a towing vehicle. The frame has a wheel assembly, a pair of elongate cradles, a conveying means for sliding a bale along each cradle and a bale loading arrangement on the trailer arranged to load bales onto the cradles. The cradles are parallel on the frame and are positioned side by side thereon arranged to receive at least one round bale on each cradle. The conveying means extends longitudinally on the frame. The bale loading arrangement has a first loading arm arranged to engage a bale for loading the bale onto a respective one of the cradles, a second loading arm arranged to engage a bale for loading the bale onto a respective second one of the cradles beside the bale loaded onto the opposite cradle by the first arm and a raising arm arranged to raise one of the bales on one of the cradles. The raising arm raises the bale such that a respective arm which loaded the raised bale can load a third bale onto the respective cradle next to the remaining bale on the opposite cradle. The raising arm lowers the raised bale onto the bales on the cradles such that the raised bale rests thereon providing the trailer with three rows of bales.

### FIELD OF THE INVENTION

The present invention relates to a vehicle for transporting bales, more particularly a vehicle such as a trailer arranged for loading and unloading of round bales.

### BACKGROUND

Various designs of transport device for cylindrical bales have been provided previously. In one arrangement, as disclosed in U.S. Pat. No. 3,942,666 (Pfremmer) bales are engaged at a front end of a trailer and flipped rearwards onto the trailer. The bales are positioned on conveyors which are arranged to move the bales rearward to accept more bales. This example of a trailer can be difficult to use because the bales have to be positioned in front of the trailer. This example also does not have an arranged to utilise a third row of bales.

Another arrangement, shown in U.S. Pat. No. 4,076,138 (Honomichl) loads bales from the side, which can be more convenient than the above mentioned arrangement, but only allows a single row of bales to be loaded onto a trailer.

Some examples of arrangements having three rows of bales are shown in U.S. Pat. Nos. 5,180,271 (Farden) and 5,320,477 (Druse, Sr.). These arrangements do not have a convenient loading arrangement on the trailer. The bales are simply loaded onto the trailer by a tractor or the like which has to drive beside the trailer loading the bales thereon. The arrangements may not be convenient in that the bales have to be precisely positioned onto the trailer in order for the trailer to properly carry the bales.

### SUMMARY

It is an object of the present invention to provide a vehicle for transporting round bales.

It is another object of the present invention to provide a convenient vehicle which has an arrangement to load three rows of bales and a convenient arrangement to unload the bales.

According to one aspect of the present invention there is provided a vehicle for transporting round bales comprising:

an elongate frame;

a wheel arrangement mounted to the frame for supporting the frame on a ground surface and arranged to roll in a direction of travel;

at least one cradle longitudinally on the frame arranged for receiving at least one bale;

a pick up arrangement on the frame arranged to pick up a bale and loading the bale into the cradle;

a chain conveyor arranged longitudinally along the cradle arranged to be driven such that the bale can be moved along the trailer within the cradle, and;

a plurality of flanges attached to the chain at positions along the length of the chain and extending parallel to the chain for engaging and supporting a bale such that the bale can be moved from one end of the cradle to another.

Preferably each flange is fastened to a respective link of the chain and extends therefrom over one or more additional links of the chain.

Preferably the flanges are wider than the chain.

Preferably each flange extends to a position overlapping an end of the next adjacent flange.

Preferably the chain is contained within an elongate housing and the flanges extend to each side of the chain to at least partly cover the housing.

Preferably the cradle includes a single chain and the flanges thereon for conveying the bales in the cradle.

According to a second aspect of the invention there is provided a vehicle for transporting round bales comprising:

an elongate frame;

a wheel assembly on the frame;

a pair of elongate cradles extending longitudinally on the frame, the cradles are parallel on the frame and are positioned side by side thereon arranged to receive at least one round bale on each cradle;

a conveying means for sliding a bale along each cradle;

a bale loading arrangement on the trailer arranged to load bales onto the cradles, the bale loading arrangement having;

a first loading arm arranged to engage a bale for loading the bale onto a respective first one of the cradles;

a second loading arm arranged to engage a bale for loading the bale onto a respective second one of the cradles beside the bale loaded onto the opposite cradle by the first arm;

a raising arm arranged to raise one of the bales on the first of the cradles;

wherein the raising arm is arranged to raise the bale on the first cradle such that the respective first arm which loaded the raised bale can load a third bale onto the respective first cradle next to the remaining bale on the second cradle;

and wherein the raising arm is arranged to lower the raised bale onto the bales on the cradles such that the raised bale rests thereon providing the vehicle with three rows of bales.

Preferably the conveying means of each cradle has at least one driven chains which is located for sliding the bales thereon.

Preferably each cradle has adjustable side rails movable inwardly and outwardly to accommodate different diameter bales.

Preferably the loading arms are each pivotally mounted at the front end of the trailer.

Preferably the raising arm is mounted for movement in a plane at the end of the cradles at right angles to the length of the cradles with a pair of spaced apart bale engaging forks extending substantially along the first cradle for engaging respective outer sides of a round bale thereon.

Preferably the first and second loading arms extend outwardly from respective sides of the trailer with bale engaging members forks in a forward direction therefrom such that the vehicle is driven towards the bale with the engaging members aligned with the bale.

### BRIEF DESCRIPTION OF THE DRAWINGS

In the accompanying drawings, which illustrate an exemplary embodiment of the present invention:

FIG. 1 is a isometric view of the present invention showing the device loaded with a row of three bales.

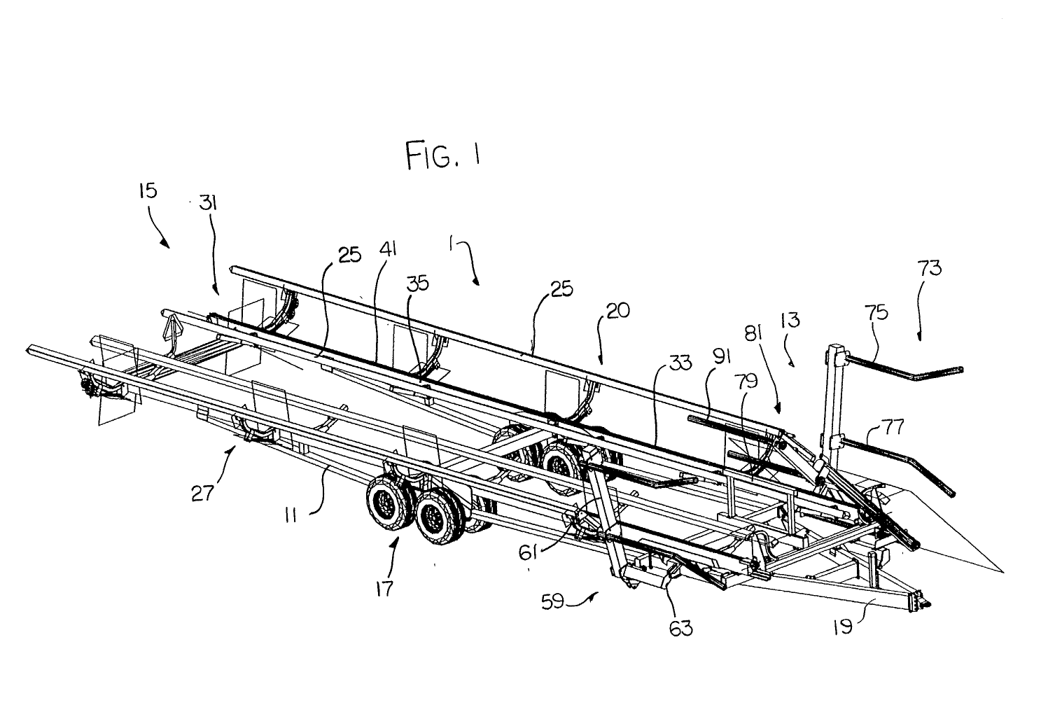

FIG. 2 is a side elevational view of the conveyor.

FIG. 3 is a front elevational view of the present invention showing two bales loaded on the cradles.

FIG. 4 is a front elevational view of the present invention showing a third bale being loaded onto the trailer.

FIG. 5 is a front elevational view of the present invention showing three bales loaded onto the trailer.

### DETAILED DESCRIPTION

Referring to the accompanying drawings, there is illustrated a round bale trailer 1 is arranged to load bales 3 for transport as well as unloading the bales. The bales are cylindrical in shape having two ends 5, an outer diameter surface 7 and an axis 9 extending through the ends.

The bale trailer has an undercarriage 11 which is arranged to support the weight of a plurality of round bales such that the bales can be pulled by a tractor or the like for transport. The undercarriage is elongate and has a first end 13 and a second end 15, defining a front and rear end respectively. A wheel assembly 17 on the undercarriage is arranged to engage the ground for movement thereon. The wheel assembly has a suspension arrangement which enables the trailer to be pulled across rough surfaces such as a field as well as on a road. At the front end of the undercarriage is a hitch 19 which is arranged to be coupled to a tractor or the like.

A pair of elongate bale cradles 20 are mounted longitudinally on the undercarriage. The cradles extend from the front end to the rear end on respective sides of the undercarriage. Each cradle is arranged to support a row of bales 21. Each cradle has an inner rail 23 and an outer rail 25. The rails are spaced apart, respectively, such that the rails engage the outer surface of a bale for support thereon. The rails are parallel and are equal in length. One or both of the outer rails and the inner rails are adjustable mounted to the undercarriage by a adjustment brackets 27 which provide suitable support for the outer rail and have a length adjustment means 29. The adjustment means can be adjusted such that the distance between each respective inner and outer rail can be widened or shortened to correspond with a variety of sized bales. The brackets are spaced along respective side of the undercarriage. The inner rails are parallel to the outer rails and may be rigidly mounted in a fixed position to the undercarriage.

The cradles are arranged such that the bales can be loaded onto the cradles end to end and the space between respective bales on a respective cradle is minimal. The width of the trailer has to be relatively narrow to correspond with regulations and such while transporting bales on roads or highways. The cradles have an open rear end 31 such that the bales can be unloaded by sliding the bales off the rear end onto the ground.

Between each inner and outer rail on a respective cradle is a single conveyor 33. The conveyor is arranged to engage the bales such that the bales can be slide along the cradle. The conveyor has a main housing or beam 35 which extends along the length of the cradle and is rigidly mounted in a fixed position to the undercarriage.

The conveyor consists of an elongate chain 37 driven by a motor. The chain extends within the housing of the conveyor and extends the length therein. A top length 39 of the chain extends through a open top portion 41 of the housing 35. The chain is arranged to be driven about two sprockets, one located at the front end and the second located at the rear end of the undercarriage. The chain has an engaging means 43 which is arranged to engage the outer surface of each bale for sliding the bale within the respective cradle.

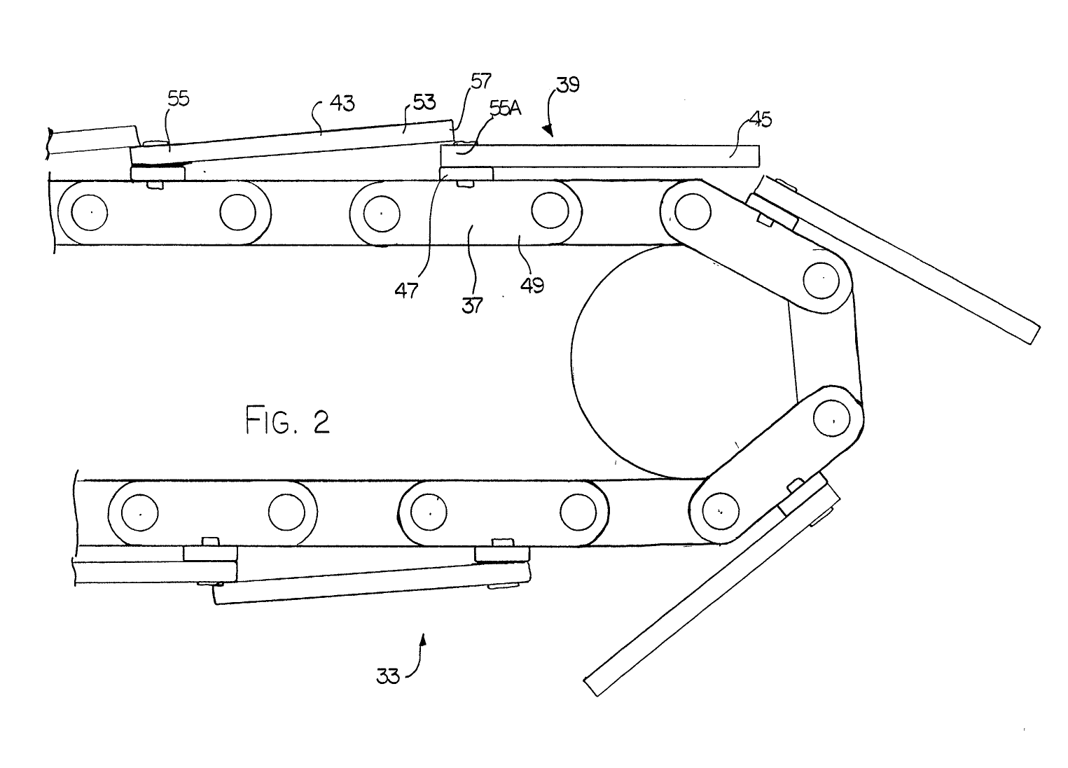

As best illustrated in FIG. 2, the engaging means is a plurality of overlapping flange members or flaps 45. Each flange members is fastened to a respective plate 47 which is welded across the top side of respective ones of a plurality of links along the length of the chain. The chain has a plurality of links 49, as commonly known, the plate is welded to every second link wherein a single flange 53 is fastened. The flanges are attached at a rear edge to the plate 47 and extend forwards in a direction along the length of the chain so that a front edges rest on top of the rear edge the next adjacent flange. The flanges are made of a stiff rubber material and are wider than the width of the chain so as to extend at each side over the housing 35 to cover the housing. The flanges are rectangular in shape and are fastened to the plate at a first end 55 and overlap the adjacent flange at a second end 57 at the adjacent flanges first end 55A. thus the whole of the housing is covered by the row of flanges 41 as they move along the housing in a transporting action The flanges are arranged such that, when the flange passes around the sprocket on the chain, the flanges separate each from the next as the chain bends so as not to interfere with the movement of the chain.

The use of the flanges or flaps on the conveyer provides an improved transport effect of the conveyer on the bales on the cradle thus allowing the use of a single conveyer mid way between the side beams of the cradle.

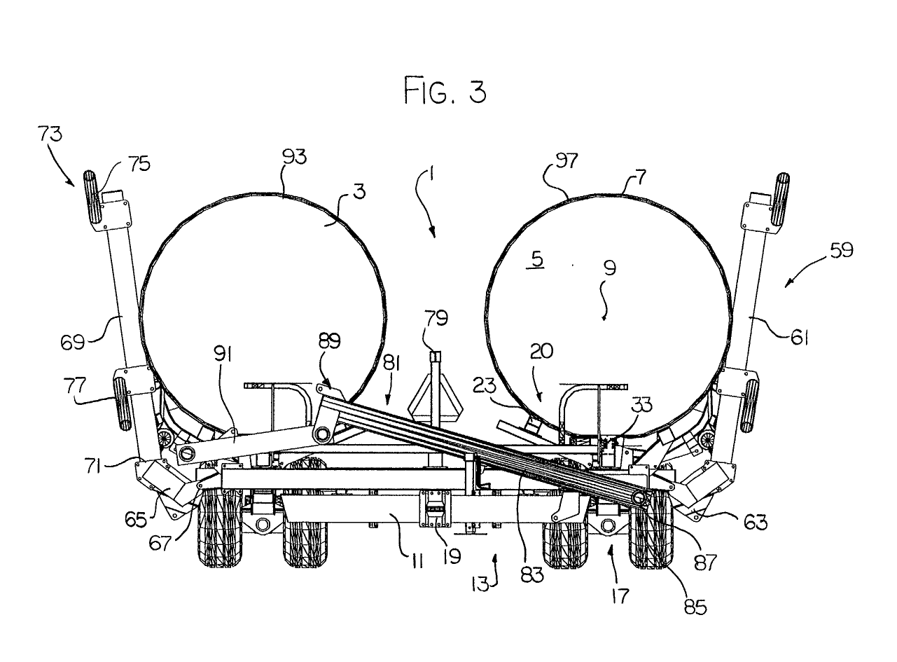

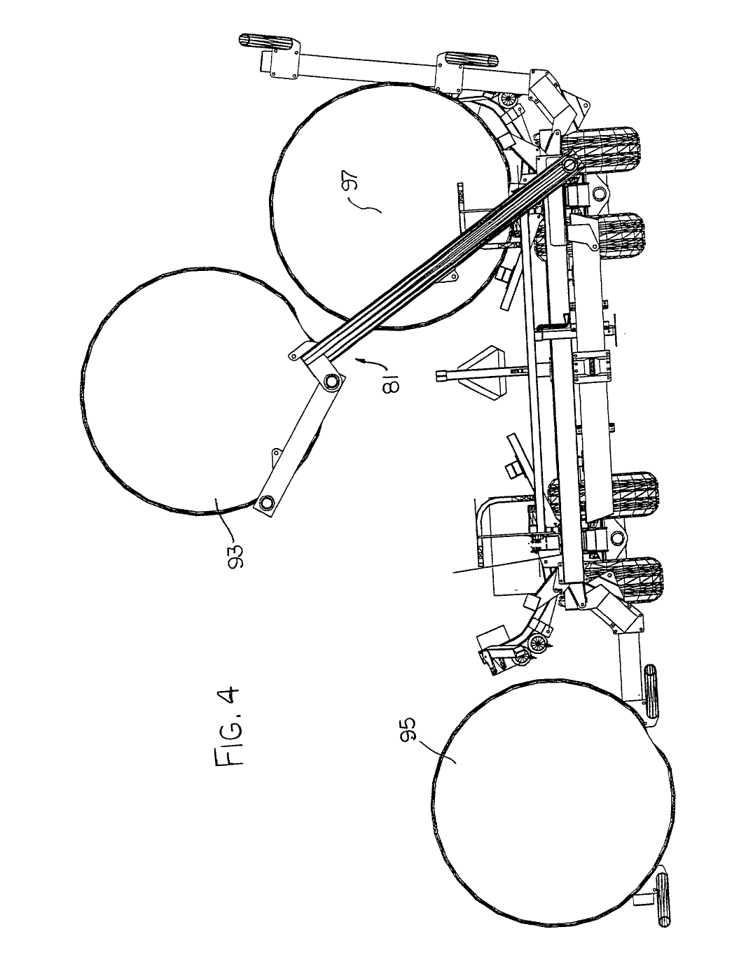

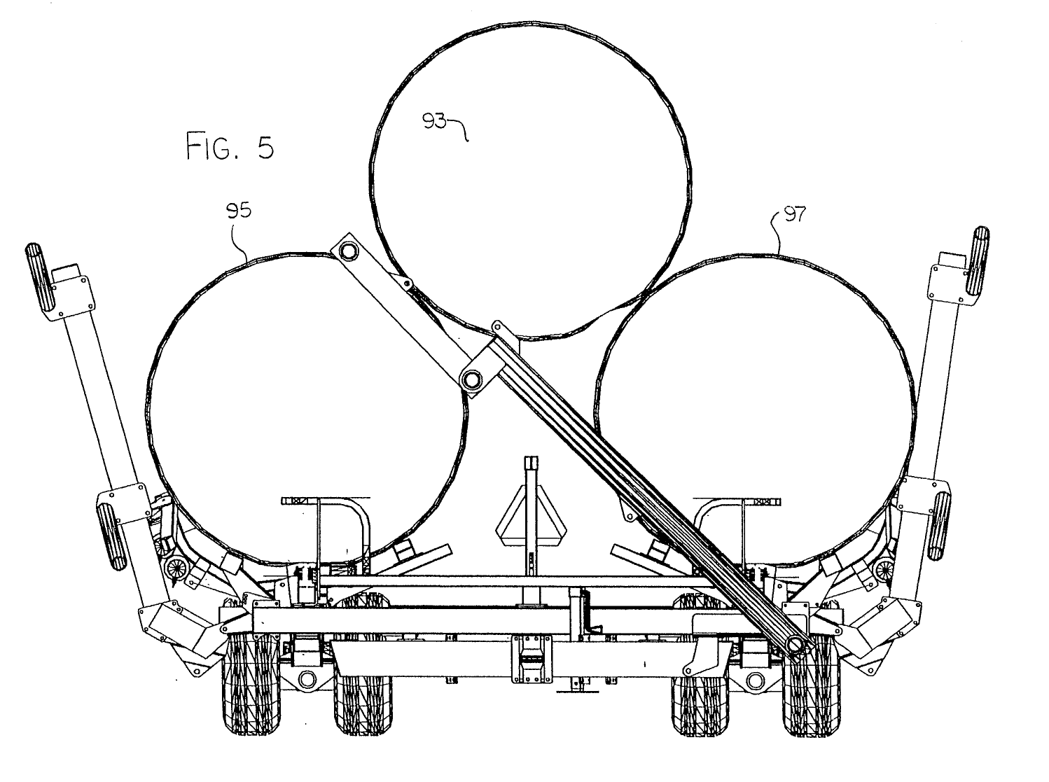

As best illustrated in FIGS. 3 to 5, a loading assembly 59 has pair of outer bale members 61 on opposing sides of the trailer which are arranged to lift a bale onto a respective cradle. The outer bale members are pivotally mounted at the front end of the carriage. The bale members are mounted on a side of the carriage and extend outwardly therefrom. The bale members have a mount portion 63 which pivotally mounts a first arm 65 to the carriage. The first arm is moved about the pivot by a hydraulic cylinder, not shown. The arm is mounted to the mount at a first end 67 and has a fixed arm 69 rigidly mounted to a second end 71. The arm is arranged such that full downward movement of the arm on the mount positions the second arm substantially parallel to the ground surface. The second arm has a pair of engaging arms 73 which extend forwards therefrom. A first engaging arm 75 is located at an outer end of the arm for engaging one side of the outer surface of a bale. A second engaging arm 77 is spaced from the first engaging arm closer to the first arm for engaging a second side of the outer surface of the bale, as best shown in FIG. 4. The hydraulic cylinder then can raise the arm such that the bale is lifted about the axis of the pivot mount. Once the arms reach the raised position the bale rolls inwards from between the engaging arms and onto the respective cradle. A bale stop 79 is positioned between the cradles at the loading area and is rigidly mounted to the carriage for stopping the roll of the bales ensuring the bales are positioned correctly on a respective cradle.

As best shown in FIG. 3, a third bale member 81 is pivotally mounted to the front end of the carriage. The third member has an elongate arm 83 which is mounted at a first end 85 to a mount 87. The mount is located on the front end and to one side of the carriage. A second end 89 of the arm has a pair of rearwardly extending engaging transversely spaced forks 91 which are arranged to be positioned at the cradle for receiving and lifting a bale. The third member is arranged to raise a first bale 93 such that a second bale 95 can replace the first bale. The arm is of sufficient length such that the bale can be raised on the forks to a necessary height to allow the second bale to be loaded onto the cradle. A third bale 97 is positioned onto the cradle opposite to the second bale such that positioning of the second bale and third bale all the first bale to be positioned on top and directly between for mounting three rows of bales on to the trailer, as best shown in FIGS. 3 to 5. The arm and the forks are then lowered to lower the top bale onto the bales on the two cradles.

The set of three of bales can now be moved along the cradle by the conveyor thus moving the three bales rearwardly away from the third arm and its forks such that a second set of three bales can be positioned on to the cradles, until the trailer is reach capacity. Unloading of the bales consists of driving the conveyor forwardly while operating the two conveyers simultaneously such that the three bales sets drop off the open rear end of the cradles in a row.

In operation, the trailer is pulled along a field. The bales are generally positioned on the field such that the operator pulls the trailer up along side of the bale. A respective bale member is lowered and the operator pulls the trailer such that the bale is positioned on the engaging arms. The bale is then raised to roll onto the cradle. The operator continues such that the set of three bales is positioned on the cradles and drives the conveyor opening the forward end of the cradles for a next set of three bales.

While one embodiment of the present invention has been described in the foregoing, it is to be understood that other embodiments are possible within the scope of the invention. The invention is to be considered limited solely by the scope of the appended claims.

1. A vehicle for transporting round bales comprising:
an elongate frame;
a wheel arrangement mounted to the frame for supporting the frame on a ground surface and arranged to roll in a direction of travel;
at least one cradle longitudinally on the frame arranged for receiving at least one bale;
a pick up arrangement on the frame arranged to pick up a bale and loading the bale into the cradle;
a chain conveyor arranged longitudinally along the cradle arranged to be driven such that the bale can be moved along the trailer within the cradle, and;
a plurality of flanges attached to the chain at positions along the length of the chain and extending parallel to the chain for engaging and supporting a bale such that the bale can be moved from one end of the cradle to another.

2. The vehicle according to claim 1 wherein each flange is fastened to a respective link of the chain and extends therefrom over one or more additional links of the chain.

3. The vehicle according to claim 1 wherein the flanges are wider than the chain.

4. The vehicle according to claim 1 wherein each flange extends to a position overlapping an end of the next adjacent flange.

5. The vehicle according to claim 1 wherein the chain is contained within an elongate housing and the flanges extend to each side of the chain to at least partly cover the housing.

6. The vehicle according to claim 1 wherein the cradle includes a single chain and the flanges thereon for conveying the bales in the cradle.

7. A vehicle for transporting round bales comprising:
an elongate frame;
a wheel assembly on the frame;
a pair of elongate cradles extending longitudinally on the frame, the cradles are parallel on the frame and are positioned side by side thereon arranged to receive at least one round bale on each cradle;
a conveying means for sliding a bale along each cradle;
a bale loading arrangement on the trailer arranged to load bales onto the cradles, the bale loading arrangement having;
a first loading arm arranged to engage a bale for loading the bale onto a respective first one of the cradles;
a second loading arm arranged to engage a bale for loading the bale onto a respective second one of the cradles beside the bale loaded onto the opposite cradle by the first arm;
a raising arm arranged to raise one of the bales on the first of the cradles;
wherein the raising arm is arranged to raise the bale on the first cradle such that the respective first arm which loaded the raised bale can load a third bale onto the respective first cradle next to the remaining bale on the second cradle;
and wherein the raising arm is arranged to lower the raised bale onto the bales on the cradles such that the raised bale rests thereon providing the vehicle with three rows of bales.

8. The vehicle according to claim 7 wherein the conveying means of each cradle has at least one driven chains which is located for sliding the bales thereon.

9. The vehicle according to claim 7 wherein each cradle has adjustable side rails movable inwardly and outwardly to accommodate different diameter bales.

10. The vehicle according to claim 7 wherein the loading arms are each pivotally mounted at the front end of the trailer.

11. The vehicle according to claim 7 wherein the raising arm is mounted for movement in a plane at the end of the cradles at right angles to the length of the cradles with a pair of spaced apart bale engaging forks extending substantially along the first cradle for engaging respective outer sides of a round bale thereon.

12. The vehicle according to claim 7 wherein the first and second loading arms extend outwardly from respective sides of the trailer with bale engaging members forks in a forward direction therefrom such that the vehicle is driven towards the bale with the engaging members aligned with the bale.
